(19) United States
(12) Patent Application Publication
(10) Pub. No.: US 2011/0311244 A1
(43) Pub. Date: Dec. 22, 2011

(54) IMAGE FORMING APPARATUS AND METHOD

(75) Inventor: Hiromichi Mitamura, Shizuoka (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/158,540

(22) Filed: Jun. 13, 2011

Related U.S. Application Data
(60) Provisional application No. 61/355,790, filed on Jun. 17, 2010.

(51) Int. Cl. G03G 15/08; G03G 13/08

(52) U.S. Cl. 399/30

(57) ABSTRACT

Certain embodiments provide an image forming apparatus including: a photoreceptor; a latent image forming unit; a developing device; a sensor that detects concentration of toner in the developing device; a storage unit that stores a prescribed time period for supplying replenishment toner and a first variation when the replenishment toner is supplied to the developing device for a prescribed time length; a toner cartridge that includes the replenishment toner and a toner discharge member; a driving unit that drives discharge of the toner discharging member; a calculating unit that calculates a second variation based on output of the sensor when the driving unit drives the toner cartridge for the prescribed time length; and a control unit that corrects the prescribed time length in the storage unit on a basis of the first and the second variations and controls the driving unit for driving for corrected time length.

### CROSS-REFERENCE TO RELATED APPLICATION

The present application claims priority under 35 U.S.C. 119 to U.S. Provisional Application Ser. No. 61/355,790, to Mitamura, filed on Jun. 17, 2010, the entire disclosure of which is incorporated herein by reference.

### FIELD

Embodiments described herein relate generally to an image forming apparatus and a toner supply control method.

### BACKGROUND

An image forming apparatus includes a mechanism that replenishes the amount of toner corresponding to the toner consumed for printing.

When toner is replenished from a toner cartridge to a developing device, a toner sensor (toner replenishment sensor) outputs a signal showing the concentration of the toner in the developing device to a controller. The concentration of toner indicates the ratio of the weight of the toner in a developer and the total weight of the toner and a carrier. The ratio is represented by weight percent.

A toner replenishment control system controls the supply amount of replenishment toner such that the concentration of the toner in the developer is kept constant. The toner replenishment control system starts supplying the replenishment toner at several predetermined timings.

The controller operates the toner cartridge for a prescribed toner replenishment time. The toner cartridge has a vane screw (a helical vane screw). The toner cartridge drops an amount of toner into the developing device.

However, the inclination of the vanes and the ease of rotation of a screw differ according to the toner cartridges.

The toner cartridges are subject to variation in regard to the assembly of parts, such as the screw. The drop amount of toner is not uniform among a plurality of toner cartridges. The drop amount of toner per unit rotational time of toner replenishment motors depends on the toner cartridges.

In relation to the same target amount of the replenishment toner, excess of the toner drop amount occurs or shortage of the toner drop amount occurs among the toner cartridges. To keep a uniform concentration of toner in a developer inside the developing device is not possible. The concentration of toner is not uniform between the toner cartridges.

### BRIEF DESCRIPTION OF THE DRAWINGS

FIG. 1 is a view showing the configuration of an image forming apparatus according to an embodiment;

FIG. 2 is a rear perspective view of a toner cartridge that is used in the image forming apparatus according to the embodiment;

FIG. 3 is a plan view showing the internal configuration of the toner cartridge that is used in the image forming apparatus according to the embodiment;

FIG. 4 is a control block diagram showing a control system that mainly controls replenishing toner in the image forming apparatus according to the embodiment;

FIG. 5A is a view showing an example of the relationship between toner concentration and output voltage of a sensor that is used in the image forming apparatus according to the embodiment;

FIG. 5B is a diagram showing an example of a reference table that is used in the image forming apparatus according to the embodiment;

FIG. 6A is a flowchart illustrating the operation of changing the supply amount of replenishment toner by the image forming apparatus according to the embodiment;

FIG. 6B is a flowchart illustrating calculating a toner replenishment time correction coefficient;

FIG. 7A is a view showing the output characteristic of a sensor when a reference drop amount of toner is dropped into a toner cartridge that is used in the image forming apparatus according to the embodiment;

FIG. 7B is a view showing an operation timing of a motor that is driven by a driving unit that is used in the image forming apparatus according to the embodiment; and

FIG. 7C is a view showing the output characteristic of the sensor when a measurement-objective toner cartridge, which is used in the image forming apparatus according to the embodiment, is driven for a prescribed toner replenishment time.

### DETAILED DESCRIPTION

Certain embodiments provide an image forming apparatus including: a photoreceptor operable to rotate; a latent image forming unit configured to form an electrostatic latent image by exposure in accordance with exposure data on the photoreceptor; a developing device configured to receive a developer in which toner and carriers are mixed, and make the electrostatic latent image visible by attaching the toner to the electrostatic latent image; a sensor configured to detect concentration of the toner in the developer in the developing device; a storage unit configured to store a prescribed time period for supplying replenishment toner and a first variation based on output of the sensor when the replenishment toner is supplied to the developing device for a prescribed time length; a toner cartridge configured to include the replenishment toner and a toner discharge member that discharges the replenishment toner in response to detection result of the sensor; a driving unit configured to drive discharge of the toner discharging member; a calculating unit configured to calculate a second variation based on the output of the sensor when the driving unit drives the toner cartridge for the prescribed time length; and a control unit configured to correct the prescribed time length in the storage unit on a basis of the first and the second variations and control the driving unit for driving for corrected time length.

Hereinafter, an image forming apparatus and a toner replenishment control method are described in detail with reference to the accompanying drawings. Further, the same components are indicated by the same reference numerals in the drawings and repetitive description is not provided.

An image forming apparatus according to an embodiment is an MFP (Multi Function Peripheral).

The toner replenishment control method according to the embodiment is a method that changes the supply amount of replenishment toner by changing the time length of a replenishment time of toner.

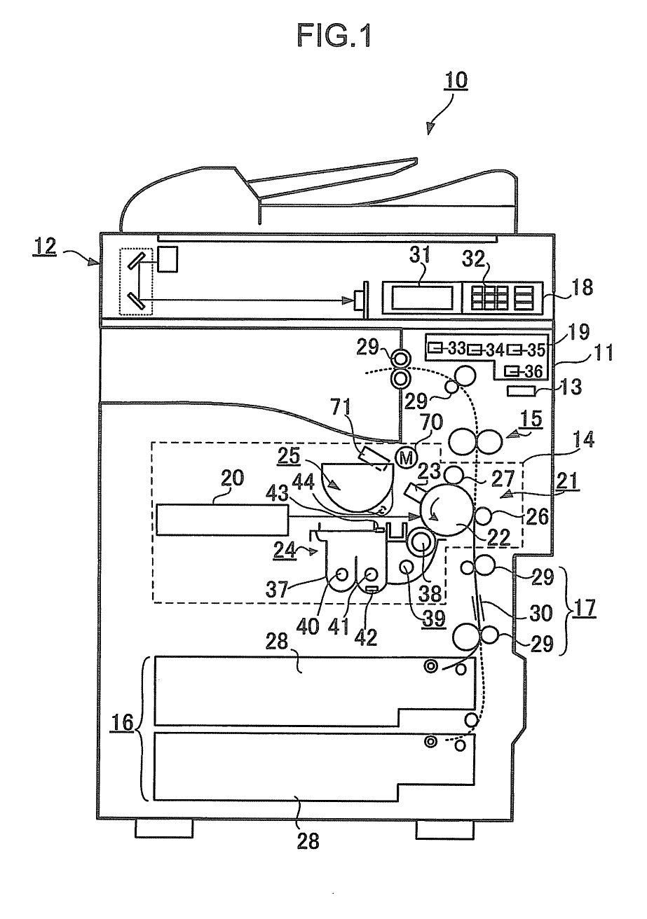

FIG. 1 shows the configuration of the MFP. The MFP 10 includes a main body 11, a scanner unit 12, an image processing unit 13, a printing process unit 14, a fixing assembly 15, a paper supply unit 16, a conveying mechanism 17, an operation panel 18, and a controller 19.

The scanner unit 12 optically scans a paper surface. The scanner unit 12 outputs image data in response to a read image signal. The image processing unit 13 corrects the image data.

The printing process unit 14 prints out a sheet by forming an image on the sheet.

The printing process unit 14 includes a laser exposure device 20 (latent image forming unit) that modulates a laser diode on the basis of the image data and an image forming unit 21 that forms a toner image on a photoreceptor drum 22 (photoreceptor). The photoreceptor drum 22 is cylindrically rotatable.

The laser exposure device 20 forms an electrostatic latent image on the surface of the photoreceptor drum 22 by exposure on the basis of exposure data.

The image forming unit 21 includes the rotary photoreceptor drum 22, a charger 23 (latent image forming unit) that charges the surface of the photoreceptor drum 22, a developing device 24 that develops the electrostatic latent image formed on the photoreceptor drum 22, and a toner cartridge 25 that supplies replenishment toner to the developing device 24.

The laser exposure device 20 and the charger 23 constitute the latent image forming unit. The laser exposure device 20 and the charger 23 form an electrostatic latent image on the photoreceptor drum 22 by exposure on the basis of the exposure data.

The image forming unit 21 includes a transfer unit that transfers the toner image developed on the photoreceptor drum 22 onto the sheet and a cleaner 27 that removes the toner remaining on the surface of the photoreceptor drum 22 after the transcribing.

Further, the MFP 10 includes a main motor 70 that transmits a rotational driving force for the photoreceptor drum 22 and the developing device 24 and a toner replenishment motor 71 that transmits a rotational driving force for a screw 48 in the toner cartridge 25.

The MFP 10 includes the toner replenishment motor 71 in the toner cartridge 25 or in the main body 11.

Further, the fixing assembly 15 fixes a not yet fixed image onto the sheet. The paper supply unit 16 sets sheets into two stages of cassettes 28. The paper supply unit 16 supplies the sheets to the printing process unit 14.

The conveying mechanism 17 includes a plurality of pairs of rollers 29, a sheet guide 30, and a driving motor. The conveying mechanism 17 conveys the sheets from the printing process unit 14 to the downstream of the fixing assembly 15.

The operation panel 18 includes a display 31 and a user interface unit 32.

The controller 19 controls the entire operation of the MFP 10. The controller 19 controls the printing process unit 14 to form the image on the sheet.

The controller 19 includes a CPU (Central Processing Unit) 33, a ROM (Read Only Memory) 34, and a RAM (Random Access Memory) 35. The ROM 34 stores the prescribed time length of a prescribed toner replenishment time. The prescribed toner replenishment time indicates a time for supplying replenishment toner.

The ROM 34 stores the prescribed time period for supplying replenishment toner. The RAM 35 reads the maximum ΔV0 of a variation (a first variation) in the memory element 73. The RAM 35 stores the maximum ΔV0 therein. The ROM 34 and the RAM 35 function as a storage unit.

The controller 19 includes a motor driving unit 36 (a driving unit). The motor driving unit 36 outputs a control signal to the main motor 70 and the toner replenishment motor 71. The motor driving unit 36 drives the discharge of the screw 48.

The developing device 24 and the toner cartridge 25 will be further described.

The developing device 24 includes a developing container 37 filled with a two-component developer. The two-component developer is a compound of the toner particles and magnetic carrier particles.

The developing device 24 includes a magnet roller 38 in the developing container 37, mixers 39, 40, and 41 that stir the developer, and a toner sensor 42 that detects toner concentration.

The magnet roller 38 has a sleeve and a plurality of magnets in the sleeve. The magnet roller 38 transports the developer onto the outer circumferential surface of the sleeve.

The developing container 37 has an opening. The magnet roller 38 contacts a magnetic brush to the photoreceptor drum 22 through the opening.

The mixers 39, 40, and 41 circulate the developer in the developing container 37. The mixers 39, 40, and 41 charge the toner particles and the carrier particles with positive and negative polarities, respectively.

The toner sensor 42 is an automatic toner control sensor that detects toner concentration. When the toner concentration increases more, output voltage of the toner sensor 42 decreased less by a change in magnetic permeability.

Further, the developing device 24 has a replenishment toner receiving hole 43 at the upper portion. The receiving hole 43 is directly connected to a toner discharging hole 44 of the toner cartridge 25. Alternatively, the receiving hole 43 is connected to the discharging hole 44 through a conveying path.

The toner cartridge 25 is inserted toward the rear from the front of the main body 11. The toner cartridge 25 is mounted in the main body 11. The discharging hole 44 of the toner cartridge 25 is opposite to the receiving hole 43 of the developing device 24. The toner cartridge 25 drops the replenishment toner into the developing container 37 through the receiving hole 43.

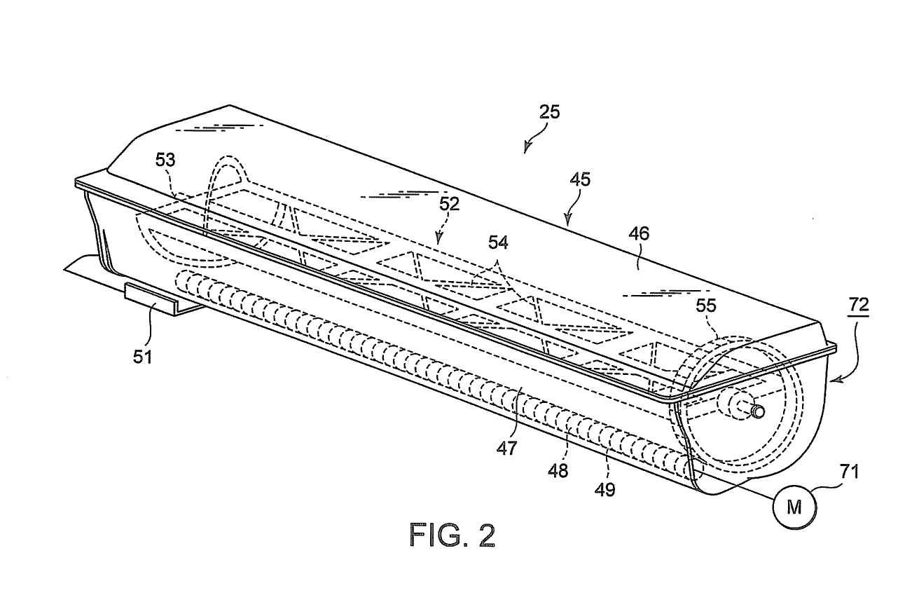

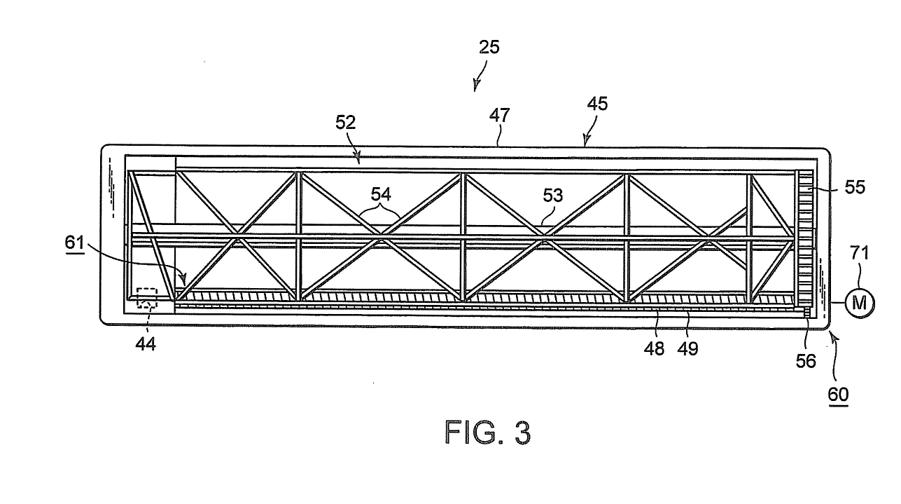

FIG. 2 is a rear perspective view of the toner cartridge 25. FIG. 3 is a plan view showing the internal configuration of the toner cartridge 25. The reference numerals described above indicate the same components. The rear face 72 is defined as the side in the depth direction of the MFP 10.

The toner cartridge 25 includes the cartridge container 45 (container) filled with replenishment toner. The cartridge container 45 includes an upper case 46 and a lower case 47.

The toner cartridge 25 includes a screw 48 (a toner discharge member) on the bottom inside the lower case 47. The screw 48 has a bar and a plurality of vanes on the outer circumferential surface of the bar. One end of the screw 48 passes through the wall of the lower case 47.

The toner replenishment motor 71 rotates the screw 48. The screw 48 discharges the replenishment toner in response to the detection of a state without toner by the toner sensor 42. Thus, the screw 48 discharges the replenishment toner in response to detection result of the toner sensor 42.

The toner discharging hole 44 (shown only in FIG. 3) is positioned at a place opposite to the other end 61 of the screw 48, on the bottom inside the lower case 47.

The toner cartridge 25 may include a shutter 51 (shown only in FIG. 2) at the lower end of the discharging hole 44. When the toner cartridge 25 is mounted in the main body 11, the shutter 51 may open the discharging hole 44, whereas when the toner cartridge 25 is drawn out of the main body 11, the shutter may cover the discharge hole 44.

The toner cartridge 25 includes a mixer 52 inside the cartridge container 45. The mixer 52 stirs the toner in the cartridge container 45.

The mixer 52 includes a shaft 53 that rotates about an axis that is parallel with the axis of the screw 48 and a plurality of frames 54 around the shaft 53.

The toner cartridge 25 includes a mixer gear 55 at one end of the mixer 52. The toner cartridge 25 includes a screw gear 56 (shown only in FIG. 3) at one end 60 of the screw. The screw gear 56 is engaged with the mixer gear 55.

The toner cartridge 25 rotates the screw 48 by using the toner replenishment motor 71. The toner cartridge 25 rotates the mixer 52 with the rotation of the screw 48.

The mixer 52 rotates. The screw 48 drops an amount of replenishment toner into the developing container 37 through the discharging hole 44.

The toner cartridge 25 has a specific drop amount of toner per unit rotational time of the toner replenishment motor 71.

The controller 19 changes the amount of replenishment toner supplied by the toner cartridge 25 by changing the replenishment time.

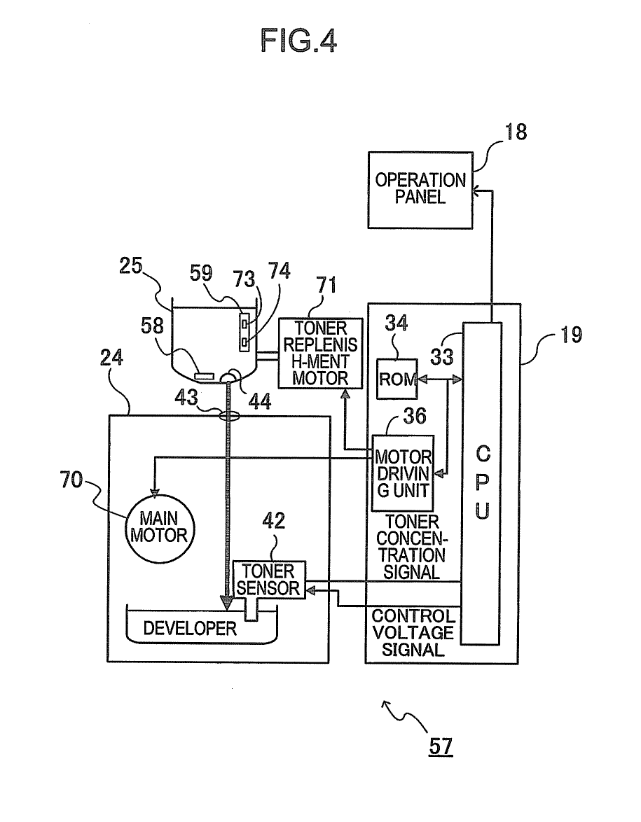

FIG. 4 is a control block diagram showing a control system that mainly controls toner replenishment. The reference numerals described above indicate the same components.

The control system 57 controls toner replenishment such that the toner concentration is kept constant in the developing device 24. The control system 57 uses an automatic toner replenishment control circuit (ATC circuit).

The control system 57 includes the toner sensor 42 (sensor) in the developing device 24, a separate toner sensor 58 in the toner cartridge 25, and toner cartridge control substrate 59 in the toner cartridge 25.

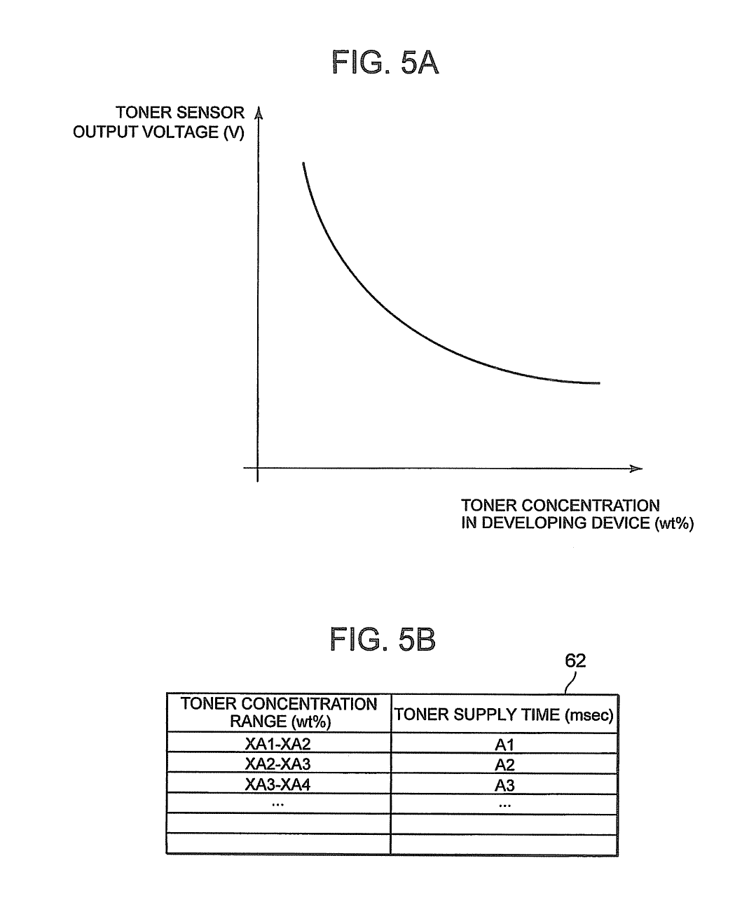

FIG. 5A is a view showing an example of the relationship between toner concentration and output voltage of the toner sensor 42. The more toner concentration increases, the less the output voltage of the toner sensor 42 decreases.

Meanwhile, the toner sensor 58 in the toner cartridge is a sensor IC (Integrated Circuit) using a piezoelectric element. The toner sensor 58 acquires the amount of toner by resonating the piezoelectric element and toner attached to the piezoelectric element. The toner sensor 58 detects the toner concentration in the cartridge container 45 from the amount of toner.

The toner cartridge control substrate 59 detects an empty state of the toner cartridge 25. The empty state means ‘toner-empty’ or ‘toner-near-empty’.

The toner cartridge control substrate 59 includes a memory element 73 (a storage medium) and a CPU 74. For example, an IC chip is used for the memory element 73. The memory element 73 stores a voltage threshold value. The CPU 74 determines that the empty state occurs, on the basis of the voltage threshold value and output voltage of the toner sensor 42.

Further, the memory element 73 stores the maximum ΔV0 of a variation (first variation) in output voltage of the toner sensor 42. The maximum ΔV0 is one of when the standard toner drop amount of toner is dropped. The standard toner drop amount of toner is a fixed value. The memory element 73 stores the maximum ΔV0 based on the output of toner sensor 42 when the replenishment toner is supplied to the developing device 24 for the prescribed time length.

Further, the control system 57 includes the controller 19, the main motor 70, the toner replenishment motor 71, and the operation panel 18. The CPU 33 sends an instruction to the motor driving unit 36 by a program readout from the ROM 34. The motor driving unit 36 rotates the main motor 70 and the toner replenishment motor 71.

The main motor 70 is a motor for stirring toner. The toner replenishment motor 71 is a motor for replenishing toner. The motor driving unit 36 drops the replenishment toner to the developing device 24 by driving the screw 48.

The control system 57 sets in advance several toner replenishment timings. The toner cartridge 25 supplies a predetermined amount of replenishment toner at the timings.

The timings are, for example, when the operation of forcible toner replenishment starts right after the toner cartridge 25 is replaced.

The forcible toner replenishment indicates a sequential process. The process is corresponding operations while detecting the empty state of the toner cartridge 25. The process is corresponding to operations while the concentration of toner in a developer returns to a prescribed value, after a new toner cartridge 25 is mounted in the main body 11. The prescribed value is a concentration-setting value that is determined in advance.

The MFP 10 calculates a ratio by using the operation from the start of the forcible toner replenishment to the return of the toner concentration, and calculates the time length after correction.

The controller 19 functions as a calculating unit.

The controller 19 calculates the maximum ΔV1 of a variation (a second variation) based on the output of the toner sensor 42 when the motor driving unit 36 drives the toner cartridge 25 for the prescribed time length.

In concrete, the controller 19 drives the toner cartridge 25 for a reference toner replenishment time (prescribed time length) T0 and then measures the maximum ΔV1 of a variation (second variation) in the output of the toner sensor 42. The controller 19 calculates the ratio of the maximum ΔV0 of a variation in output of the toner sensor 42, which is stored in advance and the maximum ΔV1.

The controller 19 functions as a control unit. The controller 19 corrects the prescribed time length in RAM 35 on the basis of the first and the second variations. The controller 19 controls the motor driving unit 36 for driving for corrected time length. In concrete, the controller 19 drives the toner replenishment motor 71 for a time longer than the reference toner replenishment time T0 on the basis of the ratio.

A toner replenishment control method according to the embodiment is a method of making the supply amount of replenishment toner substantially the same as the reference toner supply amount by extending the reference toner replenishment time T0 to a corrected toner replenishment time T1 after correction, by using the controller 19.

The method is as follows, from (a) to (d).

(a) The controller 19 reads out a measurement reference from the ROM 34. The measurement reference is the maximum ΔV0 of a variation in the output voltage of the toner sensor 25 after the standard toner drop amount of replenishment toner is supplied for the reference toner replenishment time T0. For example, a manufacturing apparatus records the maximum ΔV0 on the ROM 34 when the product is shipped out.

(b) The controller 19 measures the maximum ΔV1 of a variation in the output voltage of the toner sensor 42 after rotating the screw 48 for the reference toner replenishment time T0 by driving the toner cartridge 25 at the timing when a predetermined amount of replenishment toner is supplied.

(c) The controller 19 calculates the ratio ΔV0/ΔV1, and stores the ratio ΔV0/ΔV1 as a toner replenishment time correction coefficient. The controller 19 records the toner replenishment time correction coefficient on the memory element 73, as a specific coefficient of the toner cartridge 25.

(d) The controller 19 acquires a time length after correction, by multiplying the reference toner replenishment time T0 by the toner replenishment time correction coefficient, at the replenishment timing after the toner concentration decreases. The time length after correction is the corrected toner replenishment time T1.

The controller 19 replenishes toner by rotating the screw 48 for the corrected toner replenishment time T1.

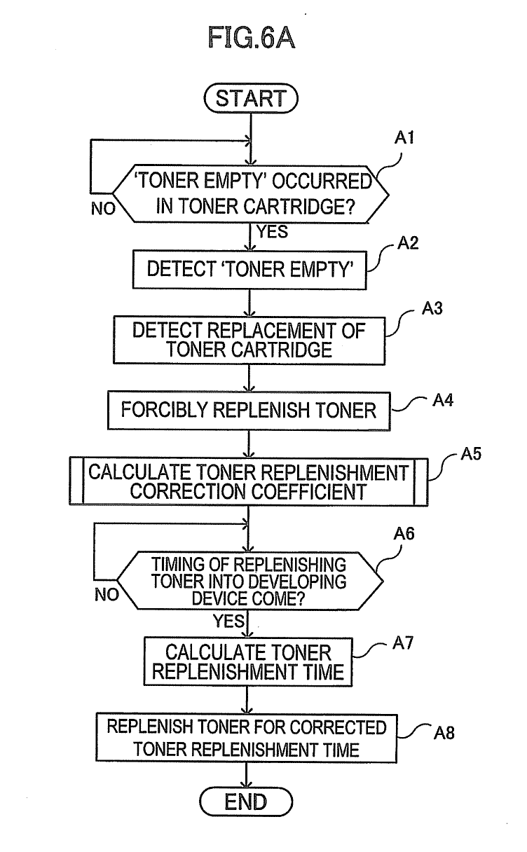

FIG. 6A is a flowchart illustrating the operation of changing the supply amount of replenishment toner by the image forming apparatus according to an embodiment.

The toner cartridge 25 is replaced, in the MFP 10 having the configuration described above.

In Act A1, the control system 57 keeps monitoring whether ‘toner empty’ occurs in the toner cartridge 25.

In detail, the printing process unit 14 consumes the toner. The toner concentration decreases. The toner sensor 42 detects the toner concentration in the developer. The control system 57 rotates the toner replenishment motor 71, when the toner concentration is low. The control system 57 supplies the replenishment toner from the toner cartridge 25 to the developing device 24.

While the toner concentration is larger than the prescribed value in Act A1, the control system 57 keeps the toner concentration stable, through a NO-route.

Further, in Act A1, the control system 57 rotates the toner replenishment motor 71. The toner sensor 42 detects the toner concentration in the developer. Thereafter, the control system 57 detects that the toner concentration does not change.

In Act A1, when the control system 57 detects ‘toner empty’, the control system 57 detects ‘toner empty’ in Act A2, though a YES-route.

In Act A3, the control system 57 detects that a new toner cartridge 25 is mounted. For example, the controller 19 detects contact between a contact point of the toner cartridge 25 and a contact point of the main body 11.

In Act A4, the control system 57 starts the operation of forcible toner replenishment. The developing device 24 stirs the replenished toner with the mixers 40 and 41. The developing device 24 conveys the toner to the toner sensor 42 in a conveying path.

In Act A5, the control system 57 starts calculating the toner replenishment time correction coefficient.

FIG. 6B is a flowchart illustrating calculating a toner replenishment time correction coefficient.

In Act B1, the controller 19 reads out a variation ΔV0 in output voltage of the toner sensor 42 in the developing device 24 when the standard toner drop amount of toner is dropped, from the ROM 34.

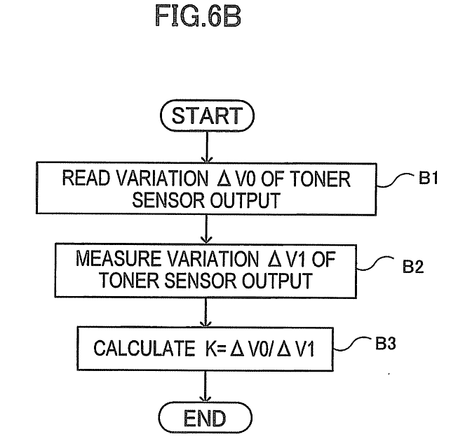

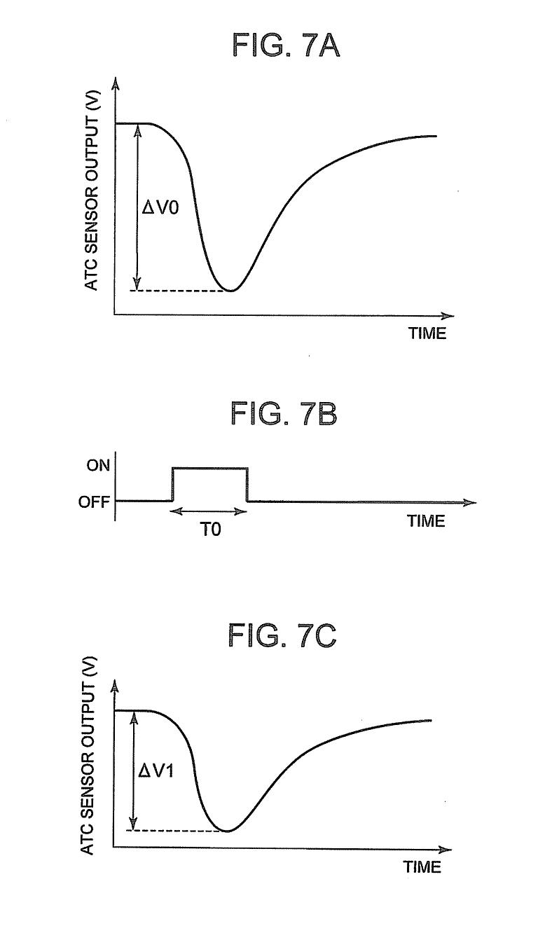

FIG. 7A is a graph showing the output characteristic of toner sensor 42 when the standard toner drop amount of toner is dropped to the toner cartridge 25. The relationship in FIG. 7A is acquired by measurement in advance. The manufacturing apparatus records the information on the output characteristic on the ROM 34, when the product is sent out.

FIG. 7B is a graph showing the operation timing of the toner replenishment motor 71 by the driving of the motor driving unit 36.

The motor driving unit 36 continuously rotates the toner replenishment motor 71 for the reference toner replenishment time T0. The standard toner drop amount of toner is dropped into the developing device 24.

The weight of the toner increases relatively to the weight of the magnetic carrier. As the toner concentration increases, the output voltage of the toner sensor 42 temporarily decreases.

After the replenishment toner starts to be supplied, the motor driving unit 36 starts to rotate the main motor 70. The developer in the developing device 24 is stirred by the main motor 70. The output voltage of the toner sensor 42 increases again.

The difference between the initial value and the bottom value in the voltage waveform of FIG. 7A corresponds to the maximum ΔV0 of a variation.

The maximum ΔV0 is the specific value of the toner cartridge 25. This is because the drop amount of toner due to the one-time rotation of the screw 48 is different for each of the toner cartridges 25.

Among a plurality of manufactured toner cartridges 25, the inclination of the vanes 49 is different for each toner cartridge 25. Ease of rotation of the screw 48 is different for each toner cartridge 25, depending on whether the mixer 52 is heavy or light.

Fluidity of the toner is different for each toner cartridge 25, depending on hardness of a lump of toner around the mixer 52 or pressure around the discharging hole 44.

The way the output voltage of the toner sensor 42 decreases in accordance with the drop amount is different for each toner cartridge 25. The maximum ΔV0 of a variation is also different for each toner cartridge 25.

Further, in Act B2 of FIG. 6B, the controller 19 measures a variation in output voltage of the toner sensor 42 by supplying the replenishment toner to the toner cartridge 25.

The controller 19 sequentially collects concentration of toner in the developer, corresponding to the operation time of the toner replenishment motor 71.

FIG. 7C is a graph showing the output characteristic of the toner sensor 42 when the measurement target toner cartridge 25 is driven for the reference toner replenishment time T0.

In this case, the controller 19 calculates the maximum (=ΔV1) of a variation in output voltage of the toner sensor 42 which corresponds to the reference toner replenishment time T0.

During the reference toner replenishment time T0, the toner replenishment motor 71 rotates. When the drop amount of toner per rotation of the screw 48 is uncertain, the toner is dropped into the developing device 24.

The controller 19 calculates the drop amount of toner per unit driving time of the toner replenishment motor 71 due to a variation in toner concentration.

As shown in FIG. 7C, as the toner concentration increases, the output voltage of the toner sensor 42 starts to decrease. Thereafter, the output voltage of the toner sensor 42 starts to increase.

The controller 19 finds the difference between the initial value and the bottom value in the voltage waveform. The controller 19 acquires the maximum ΔV1 of the variation.

In Act B3 of FIG. 6B, the controller 19 divides the maximum ΔV0 of the variation in the output voltage of the toner sensor 42 corresponding to the reference toner replenishment time T0 at the standard drop amount of toner that is stored in advance by another maximum ΔV1.

The controller 19 stores the toner replenishment time correction coefficient K (=ΔV0/ΔV1 ) showing the ratio, on the memory element 73 disposed in the toner cartridge 25.

Thereafter, the toner concentration returns to the prescribed value.

Thereafter, in Act A6 of FIG. 6A, the controller 19 monitors whether the timing of supplying the replenishment toner in the developing device 24 comes or not.

The timing is, for example, a timing when the control system 57 detects that the toner concentration decreases to the extent the toner replenishment is required, in the printing operation.

In Act A6, while the timing does not come, the controller 19 keeps the control system 57 in operation, through a NO-route.

When the timing comes in Act A6, the controller 19 starts to calculate the toner replenishment time when the toner is consumed in Act A7, through a YES-route.

The controller 19 reads out a reference table 62 recorded when the MFP 10 is shipped out, from the ROM 34.

FIG. 5B is a diagram showing an example of the reference table 62. The reference table 62 shows the relationship between the toner concentration range corresponding to respective output voltages of the toner sensor 42 and the driving time length of the toner replenishment motor 71.

The controller 19 reads out the toner replenish time length on the basis of the detected toner concentration, with reference to the reference table 62. In the relationship of Formula, T1=K*T0 (symbol ‘*’ means multiplication), the controller 19, for example, corrects the toner replenishment time A1 into a toner replenishment time after correction, K*A1.

In Act A8, the controller replenishes toner for the corrected toner replenishment time T1.

Therefore, even if the amount of toner dropped by the mounted toner cartridge 25 is different from the standard toner drop amount, the MFP 10 keeps an acquired desired toner drop amount. The prescribed toner concentration can be maintained.

The driving time of the toner replenishment motor 71 corresponding to the specific toner drop amount of the toner cartridge 25 is calculated. The controller 19 makes the amount of replenishment toner the same as the reference toner supply amount, by feeding-back the toner concentration.

Without being affected by the individual difference of the toner cartridges 25, the MFP 10 acquires a desired toner replenishment amount. As a result, the MFP 10 can keep the toner concentration in the developing device 24 constant.

Since the memory element 73 of the toner cartridge records the toner replenishment time correction coefficient K, the toner replenishment amount can be corrected, when the toner cartridge 25 is mounted in a main body other than the main body 11.

Further, the MFP 10 stores the toner replenishment time correction coefficient K on the memory element 73 as the specific coefficient of the toner cartridge 25. Another image forming apparatus reads out the toner replenishment time correction coefficient K from the memory element 73.

The toner cartridge 25 is mounted in another image forming apparatus. The image forming apparatus corrects data in a reference table stored in a memory of the image forming apparatus, and calculates a corrected toner replenishment time. The image forming apparatus can acquire a desired toner drop amount.

In the embodiment described above, although extending the time length for supplying toner is exemplified, control for reducing the time length may be performed.

Further, in the embodiment described above, an example that calculates the toner replenishment time correction coefficient K right after replacing the toner cartridge 25 was described. The timing of calculating the toner replenishment time correction coefficient K can be changed.

Another timing is for forcibly toner replacement that refreshes the toner. The forcible replacing of the toner means replacing the toner after the MFP 10 is left for a long period of time and before the MFP 10 restart operation.

The MFP 10 forcibly consumes the toner without allowing the sheet to pass. The controller 19 forcibly replaces the toner in order to maintain the image quality after the MFP 10 is left in a high-humidity environment.

Another timing is for intentionally stopping supplying replenishment toner. The timing of stopping supplying the replenishment toner means the timing at which it is required to measure again the supply amount of replenishment toner.

The toner drop amount depends on the amount of remaining toner or the pressure around the discharging hole 44. When measuring the toner drop amount, the controller 19 calculates again the toner replenishment time correction coefficient K. It is possible to acquire the accurate amount of toner remaining in the toner cartridge 25 and the accurate value of the amount of replenishment toner from the toner cartridge 25 to the developing device 24.

Further, although a magnetic permeability sensor is used as the toner sensor 42 in the embodiment described above, an optical sensor may be used as the toner sensor 42. The optical sensor detects toner concentration on the basis of light transmission.

The image forming apparatus may be a printer and a copy machine.

The image forming apparatus may be a color MFP, a printer, and a copy machine. The image forming apparatus includes developing devices for yellow (Y), magenta (M), cyan (C), and black (K), and toner cartridges for the colors of the developing devices.

The shape or structure of the toner cartridge 25 of FIGS. 2 and 3 is an example, and the shape or structure may be changed. The example of the control system 57 of FIG. 4 may also be changed.

A product that is implemented only by changing the shape, structure, or the configuration of the control system 57 does not detract from the superiority of the image forming apparatus relating to the embodiment.

In the embodiment described above, although the controller 19 performs the calculation by using the maximum ΔV0 of the variation (first variation) in output voltage of the toner sensor 42 and the maximum ΔV1 of the variation (second variation) in output of the toner sensor 42 after the toner cartridge 25 is driven, the controller 19 may use values different from the maximums.

For example, the controller 19 may use the half of the magnitude of the variation. Alternatively, the controller 19 may use a variation within a time shorter than the reference toner replenishment time (prescribed time length) T0.

While certain embodiments have been described, these embodiments have been presented by way of example only, and are not intended to limit the scope of the inventions. Indeed, the novel methods and systems described herein may be embodied in a variety of other forms; furthermore various omissions and substitutions and changes in the form of methods and systems described herein may be made without departing from the spirit of the inventions. The accompanying claims and their equivalents are intended to cover such forms or modifications as would fall within the scope and spirits of the inventions.

What is claimed is:

1. An image forming apparatus comprising:
a photoreceptor operable to rotate;
a latent image forming unit configured to form an electrostatic latent image by exposure in accordance with exposure data on the photoreceptor;
a developing device configured to receive a developer in which toner and carriers are mixed, and make the electrostatic latent image visible by attaching the toner to the electrostatic latent image;
a sensor configured to detect concentration of the toner in the developer in the developing device;
a storage unit configured to store a prescribed time period for supplying replenishment toner and a first variation based on output of the sensor when the replenishment toner is supplied to the developing device for a prescribed time length;
a toner cartridge configured to include the replenishment toner and a toner discharge member that discharges the replenishment toner in response to detection result of the sensor;
a driving unit configured to drive discharge of the toner discharging member;
a calculating unit configured to calculate a second variation based on the output of the sensor when the driving unit drives the toner cartridge for the prescribed time length; and
a control unit configured to correct the prescribed time length in the storage unit on a basis of the first and the second variations and control the driving unit for driving for corrected time length.

2. The apparatus of claim 1,
wherein when the prescribed time length is T0, the time length after the correction is T1, a maximum of the first variation is ΔV0, a maximum of the second variation is ΔV1, and a ratio of the variations is K (K=ΔV0/ΔV1 ), the control unit calculates the time length after the correction T1 by T1=K*T.

3. The apparatus of claim 1,
wherein the calculating unit measures the second variation, on forcibly toner replenishing right after replacement of the toner cartridge by occurrence of toner cartridge empty.

4. The apparatus of claim 2,
wherein the calculating unit measures the maximum of the second variation, on forcibly toner replenishing right after replacement of the toner cartridge by occurrence of toner cartridge empty.

5. The apparatus of claim 1,
wherein the calculating unit measures the second variation, in time with forcibly toner replacing that refreshes the toner in the developing device.

6. The apparatus of claim 2,
wherein the calculating unit measures the maximum of the second variation, in time with forcibly toner replacing that refreshes the toner in the developing device.

7. The apparatus of claim 1,
wherein the calculating unit measures the second variation, after intentionally stopping supplying the replenishment toner.

8. The apparatus of claim 2,
wherein the calculating unit measures the maximum of the second variation, after intentionally stopping supplying the replenishment toner.

9. The apparatus of claim 1, further comprising:
a storage medium that is disposed in the toner cartridge and stores a ratio of the variations.

10. The apparatus of claim 1,
wherein the storage unit stores a table in which output voltage of the sensor and a driving time length of the driving unit corresponding to each other in advance.

11. The apparatus of claim 1,
wherein the sensor is a magnetic permeability sensor or an optical sensor.

12. A toner replenishment control method, comprising:
storing in advance a prescribed time period for supplying replenishment toner into a developing device, and a first variation of toner concentration in a developer inside the developing device based on sensor output when the replenishment toner is supplied to the developing device for a prescribed time length;
measuring, at a toner replenishment timing, a second variation of the toner concentration by driving a toner cartridge for the prescribed time length; and
correcting the prescribed time length based on the first and the second variations and replenishing the replenishment toner to the developing device for corrected time length.

13. The method of claim 12,
wherein a time length Ti after the correction is calculated by T1=K*T0 in the correcting of the prescribed time length based on a ratio of the variations (T0 is the prescribed time length; T1 is a time length after the correction, ΔV0 is a maximum of the first variation; ΔV1 is a maximum of the second variation; and K [K=ΔV0/ΔV1 ] is the ratio).

14. The method of claim 12,
wherein the second variation is measured, on forcibly toner replenishing right after replacement of the toner cartridge by occurrence of toner cartridge empty.

15. The method of claim 13,
wherein the maximum of the second variation is measured, on forcibly toner replenishing right after replacement of the toner cartridge by occurrence of toner cartridge empty.

16. The method of claim 12,
wherein the second variation is measured, in time with forcibly toner replacing that refreshes the toner in the developing device.

17. The method of claim 13,
wherein the maximum of the second variation is measured, in time with forcibly toner replacing that refreshes the toner in the developing device.

18. The method of claim 12,
wherein the second variation is measured, after intentionally stopping supplying the replenishment toner.

19. The method of claim 13,
wherein the maximum of the second variation is measured, after intentionally stopping supplying the replenishment toner.

20. The method of claim 12,
wherein a ratio of the variations is stored in a storage medium included in the toner cartridge.
